(19) United States
(12) Patent Application Publication
(10) Pub. No.: US 2026/0288190 A1
(43) Pub. Date: Sep. 24, 2026

(54) SEMICONDUCTOR INTEGRATED CIRCUIT

(71) Applicants: KABUSHIKI KAISHA TOSHIBA, Kawasaki-shi (JP); TOSHIBA ELECTRONIC DEVICES & STORAGE CORPORATION, Kawasaki-shi (JP)

(72) Inventor: Katsuyuki IKEUCHI, Yokohama (JP)

(73) Assignees: KABUSHIKI KAISHA TOSHIBA, Kawasaki-shi (JP); TOSHIBA ELECTRONIC DEVICES & STORAGE CORPORATION, Kawasaki-shi (JP)

(21) Appl. No.: 19/311,370

(22) Filed: Aug. 27, 2025

(30) Foreign Application Priority Data
Mar. 24, 2025 (JP) 2025-048029

(51) Int. Cl. G05F 3/26

(52) U.S. Cl. CPC G05F 3/267

(57) ABSTRACT

According to one embodiment, a semiconductor integrated circuit including: a first transistor having a base connected to an output node; a second transistor having a base connected to the output node, the second transistor being different in size from the first transistor; a first resistance element connected between an emitter of the first transistor and an emitter of the second transistor; a second resistance element connected between the emitter of the second transistor and a reference node; and a compensation circuit that extracts a first current from a first node between the emitter of the first transistor and the first resistance element, and that extracts the first current from a second node between the emitter of the second transistor and the second resistance element, the first current being equivalent to half of a sum of a base current of the first transistor and a base current of the second transistor.

### CROSS-REFERENCE TO RELATED APPLICATIONS

This application is based upon and claims the benefit of priority from Japanese Patent Application No. 2025-048029, filed on Mar. 24, 2025; the entire contents of which are incorporated herein by reference.

### FIELD

Embodiments described herein relate generally to a semiconductor integrated circuit.

### BACKGROUND

In a semiconductor integrated circuit, a constant voltage to be a reference voltage may be generated using a transistor. In the semiconductor integrated circuit, it is desired to stably generate a constant voltage.

### BRIEF DESCRIPTION OF THE DRAWINGS

FIG. 1 is a block diagram illustrating a schematic configuration of a semiconductor integrated circuit according to an embodiment;

FIG. 2 is a circuit diagram illustrating a schematic configuration of a constant voltage generation circuit according to the embodiment;

FIG. 3 is a circuit diagram illustrating a detailed configuration of the constant voltage generation circuit according to the embodiment;

FIG. 4 is a chart illustrating a temperature dependence of a current amplification factor in the embodiment;

FIG. 5 is a circuit diagram illustrating a schematic configuration of a constant voltage generation circuit according to a first modification of the embodiment;

FIG. 6 is a circuit diagram illustrating a detailed configuration of the constant voltage generation circuit according to the first modification of the embodiment;

FIG. 7 is a circuit diagram illustrating a schematic configuration of a constant voltage generation circuit according to a second modification of the embodiment; and

FIG. 8 is a circuit diagram illustrating a detailed configuration of the constant voltage generation circuit according to the second modification of the embodiment.

### DETAILED DESCRIPTION

In general, according to one embodiment, there is provided a semiconductor integrated circuit including a first transistor, a second transistor, a first resistance element, a second resistance element, and a compensation circuit. The first transistor has a base connected to an output node. The second transistor has a base connected to the output node. The second transistor is different in size from the first transistor. The first resistance element is connected between an emitter of the first transistor and an emitter of the second transistor. The second resistance element is connected between the emitter of the second transistor and a reference node. The compensation circuit extracts a first current from a first node between the emitter of the first transistor and the first resistance element. The compensation circuit extracts the first current from a second node between the emitter of the second transistor and the second resistance element. The first current is equivalent to half of a sum of a base current of the first transistor and a base current of the second transistor.

Exemplary embodiments of a semiconductor integrated circuit will be explained below in detail with reference to the accompanying drawings. The present invention is not limited to the following embodiments.

### Embodiment

The semiconductor integrated circuit according to a first embodiment generates a constant voltage using a transistor, and is devised in order to stably generate a constant voltage.

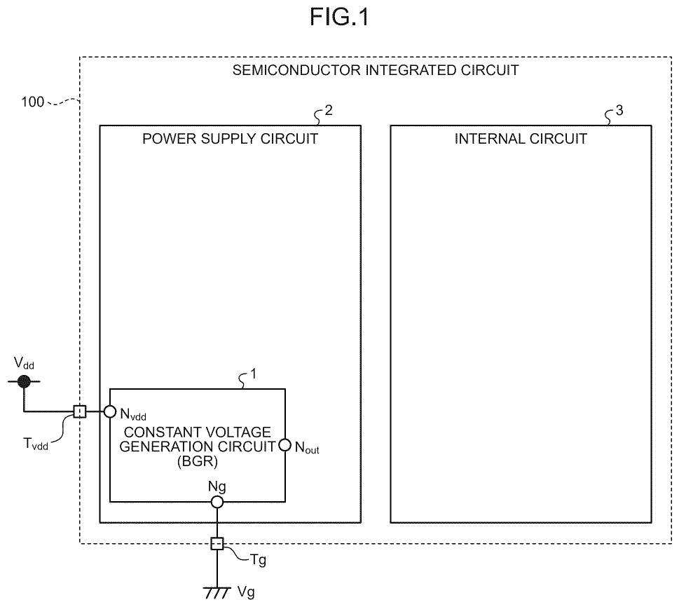

A semiconductor integrated circuit 100 can be configured as illustrated in FIG. 1. FIG. 1 is a circuit diagram illustrating a configuration of the semiconductor integrated circuit 100.

The semiconductor integrated circuit 100 has a power supply terminal Tvdd and a reference terminal Tg. The power supply terminal Tvdd is connected to an external power supply potential Vdd. The reference terminal Tg is connected to an external reference potential (for example, the ground potential) Vg.

The semiconductor integrated circuit 100 includes a constant voltage generation circuit 1. The constant voltage generation circuit 1 has a power supply node Nvdd, a reference node Ng, and an output node Nout. The power supply node Nvdd is connected to an external power supply potential Vdd via the power supply terminal Tvdd, and can receive the power supply potential Vdd from the outside via the power supply terminal Tvdd. The reference node Ng is connected to the external reference potential Vg via the reference terminal Tg, and can receive the reference potential Vg from the outside via the power supply terminal Tvdd.

The constant voltage generation circuit 1 generates a constant voltage Vbgr using the power supply potential Vdd and the reference voltage Vg that have been received. The constant voltage generation circuit 1 includes, for example, a band gap reference (BGR) type voltage generation circuit, and may generate the constant voltage Vbgr according to a band gap of the semiconductor. The constant voltage generation circuit 1 may output the constant voltage Vbgr as a reference voltage from the output node Nout.

The semiconductor integrated circuit 1 may be such that the constant voltage generation circuit 1 alone is mounted on a chip, such that a power supply circuit 2 including the constant voltage generation circuit 1 is mounted on a chip, or such that the power supply circuit 2 including the constant voltage generation circuit 1 and an internal circuit 3 may be mounted on a chip. FIG. 1 illustrates the semiconductor integrated circuit 100 in which the power supply circuit 2 including the constant voltage generation circuit 1 and the internal circuit 3 are mounted on a chip.

The power supply circuit 2 illustrated in FIG. 1 includes the constant voltage generation circuit 1. The power supply circuit 2 can generate an internal power supply voltage Vint using the constant voltage Vbgr generated by the constant voltage generation circuit 1 as a reference voltage. The power supply circuit 2 can supply the internal power supply voltage Vint to the internal circuit 3. As a result, the internal circuit 3 can operate using the internal power supply voltage Vint.

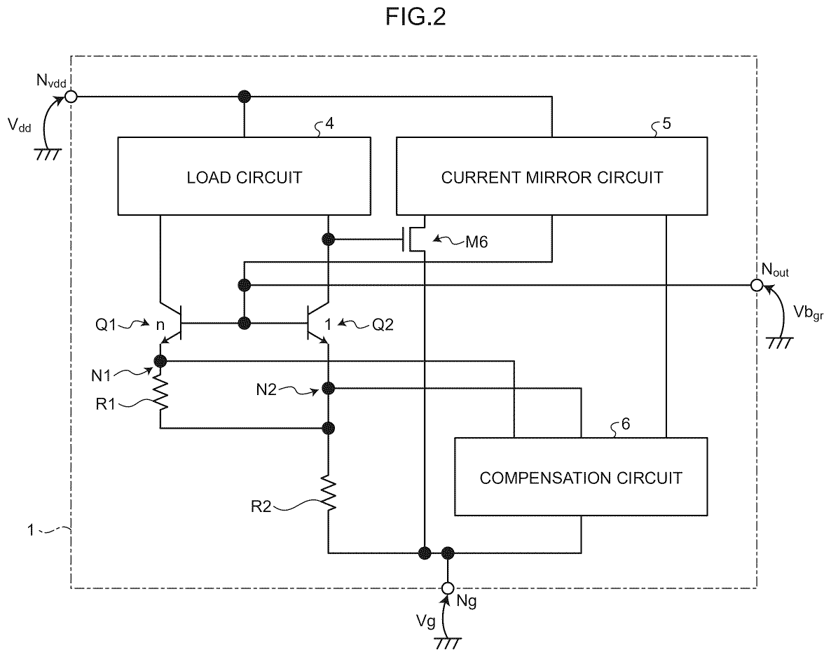

The constant voltage generation circuit 1 can be configured as illustrated in FIG. 2. FIG. 2 is a circuit diagram illustrating a schematic configuration of the constant voltage generation circuit 1.

The constant voltage generation circuit 1 includes a transistor Q1, a transistor Q2, a transistor M6, a resistance element R1, a resistance element R2, a load circuit 4, a current mirror circuit 5, and a compensation circuit 6.

The transistor Q1 is connected between the transistor Q2, the resistance element R1, the load circuit 4, the current mirror circuit 5, and the compensation circuit 6. The transistor Q1 may be an NPN type bipolar transistor. In the transistor Q1, a collector is connected to the load circuit 4, an emitter is connected to the resistance element R1 and the compensation circuit 6, and a base is connected to the transistor Q2, the current mirror circuit 5, and the output node Nout.

The transistor Q2 is connected between the transistor Q1, the resistance element R2, the load circuit 4, the current mirror circuit 5, and the compensation circuit 6. The transistor Q2 may be an NPN type bipolar transistor. The transistor Q2 has a collector connected to the load circuit 4, an emitter connected to the resistance element R2 and the compensation circuit 6, and a base connected to the transistor Q1, the current mirror circuit 5, and the output node Nout.

A size of the transistor Q1 is n times a size of the transistor Q2. n is any number greater than 1.

The transistor M6 is connected between the transistor Q2, the load circuit 4, and the current mirror circuit 5. The transistor M6 may be an N type field effect transistor. The transistor M6 has a drain connected to the current mirror circuit 5, a gate connected to a node between the load circuit 4 and the transistor Q2, and a source connected to the reference node Ng.

The resistance element R1 is connected between the transistor Q1 and the transistor Q2. In a case where the transistors Q1 and Q2 are NPN type bipolar transistors, the resistance element R1 may be connected between the emitter of the transistor Q1 and the emitter of the transistor Q2. One end of the resistance element R1 is connected to the emitter of the transistor Q1 and to the compensation circuit 6, and the other end is connected to a node between the emitter of the transistor Q2 and the resistance element R2 and to the compensation circuit 6.

The resistance element R2 is connected between the transistor Q2 and the reference node Ng. In a case where the transistor Q2 is an NPN type bipolar transistor, the resistance element R2 may be connected between the emitter of the transistor Q2 and the reference node Ng. One end of the resistance element R2 is connected to the emitter of the transistor Q2, to the other end of the resistance element R1, and to the compensation circuit 6, and the other end is connected to the reference node Ng.

The load circuit 4 is connected between the power supply node Nvdd and the transistors Q1 and Q2. In a case where the transistors Q1 and Q2 are NPN type bipolar transistors, the load circuit 4 is connected between the power supply node Nvdd, and the collector of the transistor Q1 and the collector of the transistor Q2.

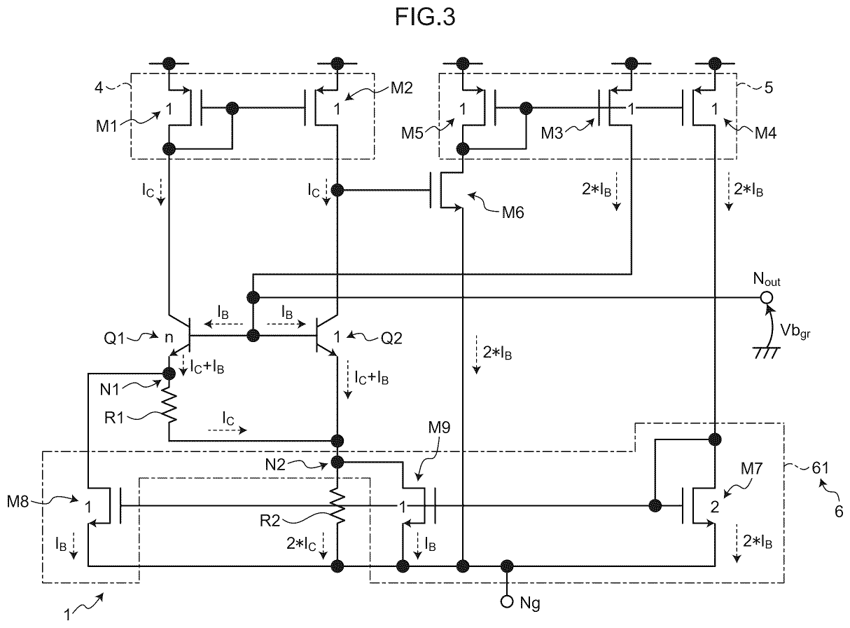

The load circuit 4 can be configured as illustrated in FIG. 3. FIG. 3 is a circuit diagram illustrating a detailed configuration of the constant voltage generation circuit 1.

The load circuit 4 includes a transistor M1 and a transistor M2. The transistor M1 is connected between the power supply node Nvdd and the transistor Q1. The transistor M2 is connected between the power supply node Nvdd and the transistor Q2. In a case where the transistors Q1 and Q2 are NPN type bipolar transistors, the transistor M1 is connected between the power supply node Nvdd and the collector of the transistor Q1. The transistor M2 is connected between the power supply node Nvdd and the transistor Q2.

The transistor M1 and the transistor M2 are connected in current mirror connection. In a case where the transistors M1 and M2 are P type field effect transistors, the transistor M1 has a source connected to the power supply node Nvdd, and a gate and a drain connected to a gate of the transistor M2 and the transistor Q2, respectively. The transistor M2 has a source connected to the power supply node Nvdd, a drain connected to the transistor Q2, and a gate connected to the gate of the transistor M1.

A size of the transistor M1 and a size of the transistor M2 are substantially equal. Accordingly, load circuit 4 has a mirror ratio of approximately 1.

The load circuit 4 supplies equivalent currents to the transistor Q1 and the transistor Q2. In a case where the transistors Q1 and Q2 are NPN type bipolar transistors, the load circuit 4 supplies equivalent currents to the collector of the transistor Q1 and the collector of the transistor Q2.

Here, since the size of the transistor Q1 is n times the size of the transistor Q2, a current density Jc1 of the transistor Q1 is different from a current density Jc2 of the transistor Q2 by about 1/n times. Accordingly, a base-emitter voltage of the transistor Q1 and a base-emitter voltage of the transistor Q2 are different from each other.

On the other hand, by connecting the resistance element R1 between the emitter of the transistor Q1 and the emitter of the transistor Q2, when a current flows through the resistance element R1, a voltage corresponding to a difference between the base-emitter voltages of the transistors Q1 and Q2 can be generated at both ends of the resistance element R1.

In addition, when the environmental temperature fluctuates, temperature fluctuations respectively of the base-emitter voltages of the transistors Q1 and Q2 may occur. For example, each of the base-emitter voltages of the transistors Q1 and Q2 may change with a negative increasing function with respect to temperature.

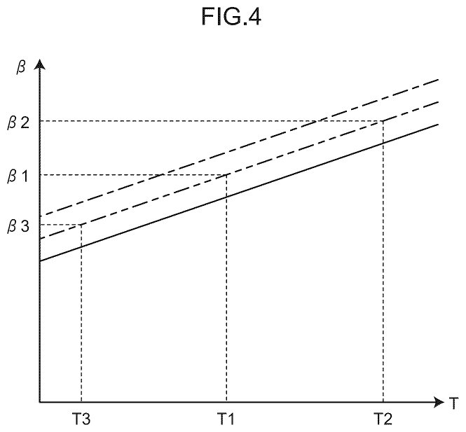

On the other hand, the current density Jc1 of the transistor Q1 and the current density Jc2 of the transistor Q2 are different from each other. Accordingly, a current amplification factor β of the transistor Q1 and a current amplification factor β of the transistor Q2 have values different from each other as illustrated in FIG. 4, and can have temperature dependence, respectively. FIG. 4 is a diagram illustrating dependence of the current amplification factor β on temperature T. In FIG. 4, the temperature dependence of the current amplification factor β of the transistor Q1 is indicated by a solid line, and the temperature dependence of the current amplification factor β of the transistor Q2 is indicated by a dash-dot line.

When values are close to each other and have substantially the same gradient of temperature change, the current amplification factor β of the transistor Q1 and the current amplification factor β of the transistor Q2 can be approximated by an average current amplification factor β of both illustrated by a dash-dot-dot line in FIG. 4. The average current amplification factor β may change with a positive increasing function with respect to temperature.

At this time, each of a base current of the transistor Q1 and a base current of the transistor Q2 can be regarded as approximately equal to an average base current I_{B}. The average base current I_{B} is a current obtained by averaging the base current of the transistor Q1 and the base current of the transistor Q2. Hereinafter, for the sake of simplicity, the average base current I_{B} is simply referred to as the base current I_{B}, and a description is given assuming that the base current I_{B} flows through the base of the transistor Q1 and the base of the transistor Q2.

When a current environmental temperature is T1, an average current amplification factor of the transistors Q1 and Q2 is β1. When an environmental temperature becomes T2 (>T1), the average current amplification factor of the transistors Q1 and Q2 becomes β2 (>β1). When an environmental temperature becomes T3 (<T1), the average current amplification factor of the transistors Q1 and Q2 becomes β3 (<β1).

Accordingly, each of emitter currents of the transistors Q1 and Q2 may change with a positive increasing function with respect to temperature.

Therefore, by connecting the resistance element R2 between the emitters of the transistors Q1 and Q2 and the reference node Ng, the voltage across terminals of the resistance element R2 can change with a positive increasing function with respect to temperature. As a result, it is expected that an influence of the temperature dependence of the base-emitter voltages of the transistors Q1 and Q2 that can change with a negative increasing function with respect to the temperature can be reduced by the temperature dependence of the voltage across the terminals of the resistance element R2.

However, among collector currents and the base currents included in the emitter currents of the transistors Q1 and Q2, the temperature change characteristic of the collector current can change symmetrically with respect to the temperature change characteristic of the base-emitter voltage, whereas the temperature change characteristic of the base current can change asymmetrically with respect to the temperature change characteristic of the base-emitter voltage. Therefore, when the base currents of the transistors Q1 and Q2 flow through the resistance element R2, it may be difficult to reduce the temperature dependence.

On the other hand, in the constant voltage generation circuit 1, as illustrated in FIG. 2, the current mirror circuit 5 and the compensation circuit 6 are provided, and the base current I_{B} is extracted from a node N1 and the base current I_{B} is extracted from a node N2. The node N1 is disposed between the transistor Q1 and the resistance element R1. The node N2 is disposed between the transistor Q2 and the resistance element R2.

The current mirror circuit 5 is connected between the transistor Q1 and the transistor Q2, and the compensation circuit 6. In a case where the transistors Q1 and Q2 are NPN type bipolar transistors, an input side of the current mirror circuit 5 is connected to the node between the load circuit 4 and the transistor Q2 via the transistor M6, and an output side is connected to the compensation circuit 6.

As illustrated in FIG. 3, the current mirror circuit 5 includes a transistor M3, a transistor M4, and a transistor M5. The transistor M3, the transistor M4, and the transistor M5 are connected to each other in current mirror connection. In a case where the transistors Q1 and Q2 are NPN type bipolar transistors and the transistors M3, M4, and M5 are P type field effect transistors, the transistor M3 has a source connected to the power supply node Nvdd, a drain connected to the base of the transistor Q1 and the base of the transistor Q2, and a gate connected to a gate of the transistor M4 and a gate of the transistor M5. The transistor M4 has a source connected to the power supply node Nvdd, a drain connected to the compensation circuit 6, and the gate connected to the gate of the transistor M3 and the gate of the transistor M4. The transistor M5 has a source connected to the power supply node Nvdd, and the gate and a drain connected to the gate of the transistor M3, the gate of the transistor M4, and the drain of the transistor M6.

A size of the transistor M3, a size of the transistor M4, and a size of the transistor M5 are substantially equal. Accordingly, a mirror ratio is approximately 1.

Note that the transistor M6 has the gate connected to the drain of the transistor M2 and the source connected to the reference node Ng, and can function as an inverting amplifier.

A loop including the drain of the transistor M6→the drain of the transistor M5→the gate of the transistor M5→the gate of the transistor M3→the drain of the transistor M3→the base of the transistor Q2→the collector of the transistor Q2→the gate of the transistor M6→the drain of the transistor M6 functions as a feedback loop. For example, a voltage corresponding to the current Ic from the load circuit 4 is applied to the gate of the transistor M6, and accordingly, a drain current flowing through the transistor M6 is copied from the drain of the transistor M5 to the drain of the transistor M3 at a mirror ratio of approximately 1. The copied current flows into the base of the transistor Q1 and the base of the transistor Q2, but since the load circuit 4 supplies equivalent currents to the transistor Q1 and the transistor Q2, a feedback is provided so that the drain current flowing through the transistor M6 becomes 2×I_{B}.

The current mirror circuit 5 receives a current 2×I_{B} obtained by summing the base current I_{B} of the transistor Q1 and the base current I_{B} of the transistor Q2 on the input side (the drain of the transistor M5), copies the current 2×I_{B} to the output side (the drain of the transistor M4) at a mirror ratio of approximately 1, and supplies the current 2×I_{B} from the output side to the compensation circuit 6.

The compensation circuit 6 illustrated in FIG. 2 is connected between the node N1, the node N2, and the current mirror circuit 5, and the reference node Ng.

As illustrated in FIG. 3, the compensation circuit 6 includes a current mirror circuit 61. The current mirror circuit 61 has an input side connected to the output side of the current mirror circuit 5, and an output side connected to the resistance element R1 parallelly with respect to the node N1 and connected to the resistance element R2 parallelly with respect to the node N2.

The current mirror circuit 61 includes a transistor M7, a transistor M8, and a transistor M9. The transistor M7, the transistor M8, and the transistor M9 are connected to each other in current mirror connection. In a case where the transistors Q1 and Q2 are NPN type bipolar transistors and the transistors M7, M8, and M9 are N type field effect transistors, the transistor M7 has a source connected to the reference node Ng, and a gate and a drain connected to a gate of the transistor M8 and a gate of the transistor M9. The transistor M8 has a source connected to the reference node Ng, a drain connected to the node N1, and the gate connected to the gate of the transistor M7 and the gate of the transistor M8. The transistor M9 has a source connected to the reference node Ng, a drain connected to the node N2, and the gate connected to the gate of the transistor M7 and the gate of the transistor M8.

A size of the transistor M7 is approximately twice a size of the transistor M8 and approximately twice a size of the transistor M9. Accordingly, a mirror ratio is approximately ½.

The current mirror circuit 61 receives the current 2×I_{B} on an input side, copies the current 2×I_{B} to an output side at a mirror ratio of approximately ½, and causes the current I_{B} to flow on the output side. As a result, the current mirror circuit 61 extracts the base current I_{B} from the node N1 and extracts the base current I_{B} from the node N2.

As described above, in the embodiment, in the constant voltage generation circuit 1 of the semiconductor integrated circuit 100, the current mirror circuit 5 supplies the total current 2×I_{B} obtained by summing the currents received from the bases of the transistors Q1 and Q2 to the compensation circuit 6. The compensation circuit 6 copies the current 2×I_{B} to the output side at a mirror ratio of approximately ½, and on the output side, extracts the base current I_{B} from the node N1 and extracts the base current I_{B} from the node N2. As a result, while suppressing an influence of the temperature dependence of the base currents of the transistors Q1 and Q2, the influence of the temperature dependence of the base-emitter voltages of the transistors Q1 and Q2 that can change with a negative increasing function with respect to the temperature can be reduced by the temperature dependence of the voltage across the terminals of the resistance element R2 that can change with a positive increasing function with respect to temperature. As a result, the voltage between the collectors of the transistors Q1 and Q2 and the reference node Ng can be maintained substantially constant with respect to the fluctuation of the environmental temperature, and the constant voltage Vbgr output from the output node Nout can be maintained substantially constant.

Note that, as a first modification of the embodiment, it is possible to devise, in a constant voltage generation circuit 201 of a semiconductor integrated circuit 200, for example, measures to stably equalize a collector current I_{C} of the transistor Q1 and a collector current I_{C} of the transistor Q2, in a case where the transistors Q1 and Q2 are NPN type bipolar transistors.

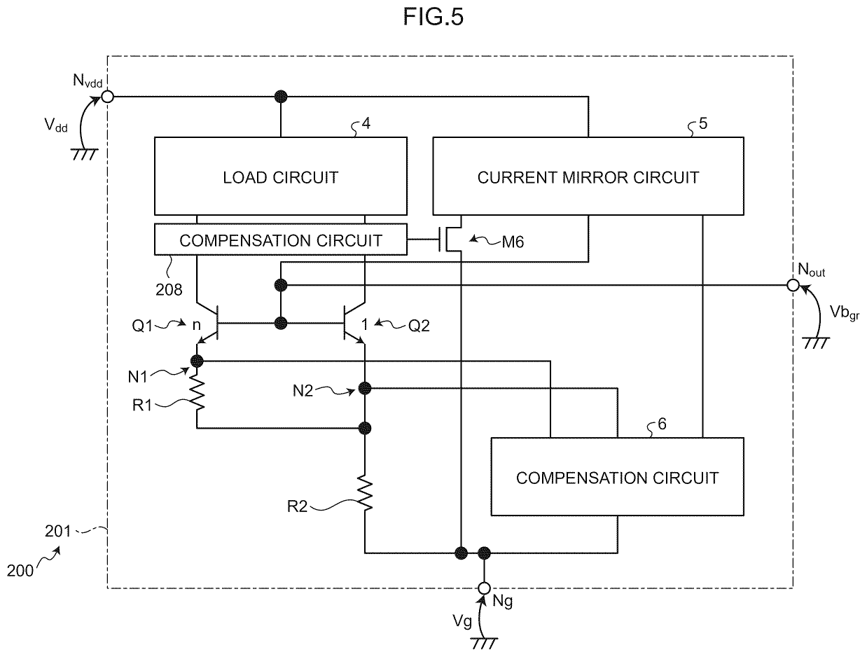

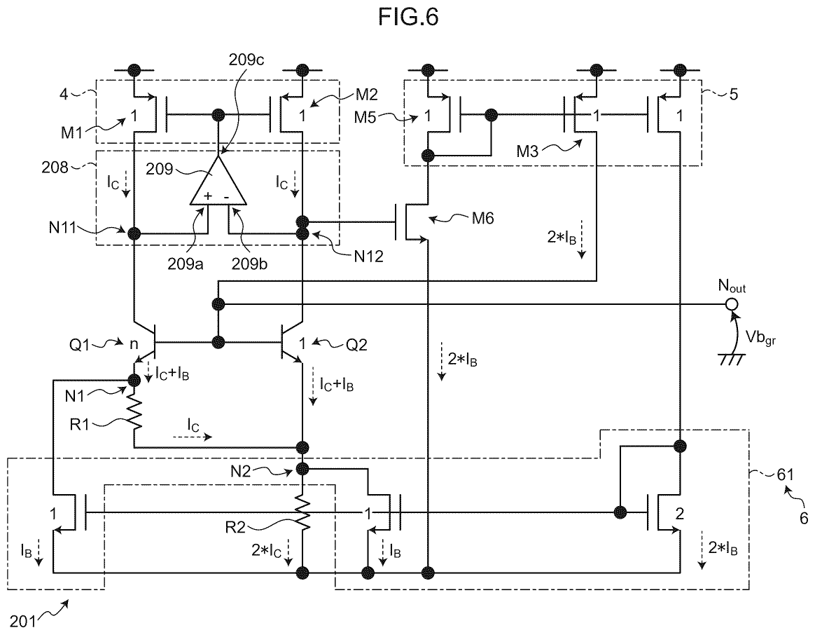

As illustrated in FIGS. 5 and 6, the constant voltage generation circuit 201 of the semiconductor integrated circuit 200 may further include a compensation circuit 208. FIG. 5 is a circuit diagram illustrating a schematic configuration of the constant voltage generation circuit 201 in the first modification of the embodiment. FIG. 6 is a circuit diagram illustrating a detailed configuration of the constant voltage generation circuit 201 in the first modification of the embodiment.

The compensation circuit 208 illustrated in FIG. 5 is connected between the load circuit 4, the transistors Q1 and Q2, and the transistor M6. The compensation circuit 208 receives a voltage on a side of the transistor Q1 and a voltage on a side of the transistor Q2 from the load circuit 4, and supplies a control signal corresponding to a difference between a current on a side of the transistor Q1 and a current on a side of the transistor Q2 to the load circuit 4.

As illustrated in FIG. 6, the compensation circuit 208 includes a differential amplifier 209. The differential amplifier 209 has a non-inverting input terminal 209a connected to a node N11, an inverting input terminal 209b connected to a node N12, and an output terminal 209c connected to the gates of the transistors M1 and M2. The node N11 is connected between the load circuit 4 and the transistor Q1. The node N12 is connected between the load circuit 4 and the transistor Q2.

In a case where the transistors M1 and M2 are P type field effect transistors and the transistors Q1 and Q2 are NPN type bipolar transistors, the node N11 is connected between the drain of the transistor M1 and the collector of the transistor Q1. The node N12 is connected between the drain of the transistor M2 and the collector of the transistor Q2. The transistors M1 and M2 can also be regarded to be connected in current mirror connection via the differential amplifier 209.

The differential amplifier 209 receives a voltage of the node N11 by the non-inverting input terminal 209a and receives a voltage of the node N12 by the inverting input terminal 209b. The differential amplifier 209 outputs a voltage corresponding to a difference between the voltage of the node N11 and the voltage of the node N12 from the output terminal 209c. The differential amplifier 209 may supply the voltage corresponding to the difference between the voltage of the node N11 and the voltage of the node N12 to the load circuit 4 as a control signal.

As a result, the compensation circuit 208 can adjust the load circuit 4 so that the current on the side of the transistor Q1 and the current on the side of the transistor Q2 become equivalent. According to the adjustment result, the compensation circuit 208 supplies the current on the side of the transistor Q1 to the transistor Q1 and supplies the current on the side of the transistor Q2 to the transistor Q2.

Note that the loop including the drain of the transistor M6→the drain of the transistor M5→the gate of the transistor M5→the gate of the transistor M3→the drain of the transistor M3→the base of the transistor Q2→the collector of the transistor Q2→the gate of the transistor M6→the drain of the transistor M6 functions as a feedback loop. For example, a voltage corresponding to the current Ic from the load circuit 4 is applied to the gate of the transistor M6, and accordingly, a drain current flowing through the transistor M6 is copied from the drain of the transistor M5 to the drain of the transistor M3 at a mirror ratio of approximately 1. The copied current flows into the base of the transistor Q1 and the base of the transistor Q2, but since the load circuit 4 supplies equivalent currents to the transistor Q1 and the transistor Q2, a feedback is provided so that the drain current flowing through the transistor M6 becomes 2×I_{B}. This point is similar to the embodiment.

In this way, the load circuit 4 can stably supply the equivalent currents to the transistor Q1 and the transistor Q2 through the compensation circuit 208. As a result, the collector current I_{C} of the transistor Q1 and the collector current I_{C} of the transistor Q2 can be stably equalized.

Alternatively, as a second modification of the embodiment, it is possible to devise, in a constant voltage generation circuit 301 of a semiconductor integrated circuit 300, for example, another measure to suppress an influence of a difference between the collector current I_{C} of the transistor Q1 and the collector current I_{C} of the transistor Q2, in a case where the transistors Q1 and Q2 are NPN type bipolar transistors.

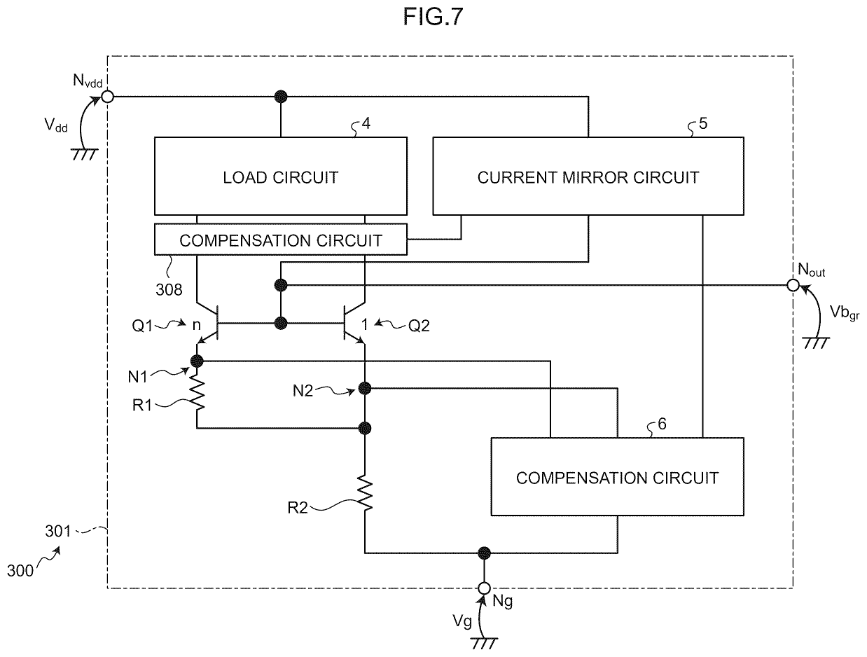

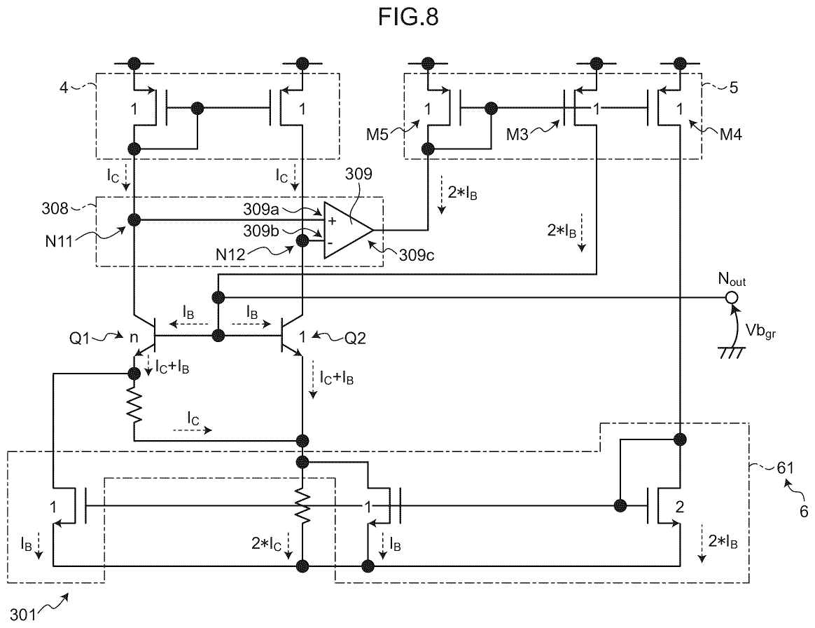

As illustrated in FIGS. 7 and 8, the constant voltage generation circuit 301 of the semiconductor integrated circuit 300 may further include a compensation circuit 308. FIG. 7 is a circuit diagram illustrating a schematic configuration of the constant voltage generation circuit 301 in the second modification of the embodiment. FIG. 8 is a circuit diagram illustrating a detailed configuration of the constant voltage generation circuit 301 in the second modification of the embodiment.

The compensation circuit 308 illustrated in FIG. 7 is connected between the load circuit 4 and the current mirror circuit 5 and the transistors Q1 and Q2. The compensation circuit 308 receives a voltage on a side of the transistor Q1 and a voltage on a side of the transistor Q2 from the load circuit 4, and supplies a control signal corresponding to a difference between a current on a side of the transistor Q1 and a current on a side of the transistor Q2 to the current mirror circuit 5.

As illustrated in FIG. 8, the compensation circuit 308 includes a differential amplifier 309. The differential amplifier 309 has a non-inverting input terminal 309a connected to the node N11, an inverting input terminal 309b connected to the node N12, and an output terminal 309c connected to the drain of the transistor M5. The node N11 is connected between the load circuit 4 and the transistor Q1. The node N12 is connected between the load circuit 4 and the transistor Q2.

In a case where the transistors M1 and M2 are P type field effect transistors and the transistors Q1 and Q2 are NPN type bipolar transistors, the node N11 is connected between the drain of the transistor M1 and the collector of the transistor Q1. The node N12 is connected between the drain of the transistor M2 and the collector of the transistor Q2.

The differential amplifier 309 receives the voltage of the node N11 by the non-inverting input terminal 309a and receives the voltage of the node N12 by the inverting input terminal 309b. The differential amplifier 309 outputs a voltage corresponding to a difference between the voltage of the node N11 and the voltage of the node N12 from the output terminal 309c. The differential amplifier 309 may supply the voltage corresponding to the difference between the voltage of the node N11 and the voltage of the node N12 to the current mirror circuit 5 as a control signal.

As a result, the current mirror circuit 5 copies a correction current corresponding to the difference between the collector current on the side of the transistor Q1 and the collector current on the side of the transistor Q2 to the input side and the output side at a mirror ratio of approximately 1, supplies the correction current from the input side to the transistors Q1 and Q2, and supplies the correction current from the output side to the compensation circuit 6.

Note that a loop including the output node 309c of the differential amplifier 309→the drain of the transistor M5→the gate of the transistor M5→the gate of the transistor M3→the drain of the transistor M3→the base of the transistor Q2→the collector of the transistor Q2→the input node 309b of the differential amplifier 309→the output node 309c of the differential amplifier 309 functions as a feedback loop. For example, a voltage corresponding to the current Ic from the load circuit 4 is applied to the input node 309b of the differential amplifier 309, and accordingly, the current flowing through the output node 309c of the differential amplifier 309 is copied from the drain of the transistor M5 to the drain of the transistor M3 at a mirror ratio of approximately 1. The copied current flows into the base of the transistor Q1 and the base of the transistor Q2, but since the load circuit 4 supplies equivalent currents to the transistor Q1 and the transistor Q2, a feedback is provided so that the current flowing through the output node 309c of the differential amplifier 309 becomes 2×I_{B}. This point is similar to the embodiment.

In this way, in the compensation circuit 308, the current mirror circuit 5 causes the correction current corresponding to the difference between the collector current on the side of the transistor Q1 and the collector current on the side of the transistor Q2 to flow to the input side and the output side of the current mirror circuit 5. As a result, the current 2×I_{B} flowing on the input side and the output side of the current mirror circuit 5 may be corrected, and it is possible to suppress the influence of the difference between the collector current I_{C} of the transistor Q1 and the collector current I_{C} of the transistor Q2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor integrated circuit comprising:
a first transistor having a base connected to an output node;
a second transistor having a base connected to the output node, the second transistor being different in size from the first transistor;
a first resistance element connected between an emitter of the first transistor and an emitter of the second transistor;
a second resistance element connected between the emitter of the second transistor and a reference node; and
a compensation circuit that extracts a first current from a first node between the emitter of the first transistor and the first resistance element, and that extracts the first current from a second node between the emitter of the second transistor and the second resistance element, the first current being equivalent to half of a sum of a base current of the first transistor and a base current of the second transistor.

2. The semiconductor integrated circuit according to claim 1, further comprising:
a first current mirror circuit whose input side is connected to the base of the first transistor and the base of the second transistor, wherein
the compensation circuit includes:
a second current mirror circuit whose input side is connected to an output side of the first current mirror circuit, and whose output side is connected to the first resistance element parallelly with respect to the first node and to the second resistance element parallelly with respect to the second node.

3. The semiconductor integrated circuit according to claim 2, wherein
a mirror ratio of the first current mirror circuit is approximately 1, and
a mirror ratio of the second current mirror circuit is approximately ½.

4. The semiconductor integrated circuit according to claim 1, further comprising:
a load circuit that supplies equivalent currents to a collector of the first transistor and a collector of the second transistor.

5. The semiconductor integrated circuit according to claim 4, further comprising:
a differential amplifier circuit including a first input node connected to the collector of the first transistor, a second input node connected to the collector of the second transistor, and an output node connected to a control terminal of the load circuit.

6. The semiconductor integrated circuit according to claim 2, further comprising:
a differential amplifier circuit including a first input node connected to a collector of the first transistor, a second input node connected to a collector of the second transistor, and an output node connected to the first current mirror circuit.

7. The semiconductor integrated circuit according to claim 4, wherein
a size of the first transistor is n times a size of the second transistor, where n is a number greater than 1.

8. The semiconductor integrated circuit according to claim 7, further comprising:
a first current mirror circuit whose input side is connected to the base of the first transistor and the base of the second transistor, wherein
the compensation circuit includes:
a second current mirror circuit whose input side is connected to an output side of the first current mirror circuit, and whose output side is connected to the first resistance element parallelly with respect to the first node and to the second resistance element parallelly with respect to the second node.

9. The semiconductor integrated circuit according to claim 8, wherein
a mirror ratio of the first current mirror circuit is approximately 1, and
a mirror ratio of the second current mirror circuit is approximately ½.

10. The semiconductor integrated circuit according to claim 8, wherein
the first current mirror circuit includes:
a third transistor connected to the base of the first transistor and the base of the second transistor; and
a fourth transistor connected to the third transistor in current mirror connection and connected to the second current mirror circuit, and
the second current mirror circuit includes:
a fifth transistor connected to the fourth transistor;
a sixth transistor connected to the fifth transistor in current mirror connection and connected to the first resistance element parallelly with respect to the first node; and
a seventh transistor connected to the fifth transistor in current mirror connection and connected to the second resistance element parallelly with respect to the second node.

11. The semiconductor integrated circuit according to claim 10, wherein
a size of the fourth transistor is equivalent to a size of the third transistor,
a size of the sixth transistor is approximately ½ of a size of the fifth transistor, and
a size of the seventh transistor is approximately ½ of the size of the fifth transistor.

12. The semiconductor integrated circuit according to claim 11, wherein
a mirror ratio of the first current mirror circuit is approximately 1, and
a mirror ratio of the second current mirror circuit is approximately ½.

13. The semiconductor integrated circuit according to claim 10, wherein
the load circuit includes:
an eighth transistor connected to the first transistor; and
a ninth transistor connected to the eighth transistor in current mirror connection and connected to the second transistor.

14. The semiconductor integrated circuit according to claim 13, wherein
a size of the ninth transistor is equivalent to a size of the eighth transistor.

15. The semiconductor integrated circuit according to claim 14, wherein
a mirror ratio of the load circuit is approximately 1.

16. The semiconductor integrated circuit according to claim 13, wherein
the first current mirror circuit further includes:
a tenth transistor that is connected to the third transistor in current mirror connection, and
the semiconductor integrated circuit further includes:
an eleventh transistor having a gate connected to a node between the ninth transistor and the second transistor and a drain connected to the tenth transistor.

17. The semiconductor integrated circuit according to claim 1, wherein
a current amplification factor of the first transistor and a current amplification factor of the second transistor have temperature dependence.

18. The semiconductor integrated circuit according to claim 17, wherein
an average current amplification factor of the current amplification factor of the first transistor and the current amplification factor of the second transistor changes with a positive increasing function with respect to temperature.

19. The semiconductor integrated circuit according to claim 1, wherein
each of a base-emitter voltage of the first transistor and a base-emitter voltage of the second transistor respectively changes with a negative increasing function with respect to temperature, and
a voltage across terminals of the second resistance element changes with a positive increasing function with respect to temperature.

20. The semiconductor integrated circuit according to claim 1, wherein
each of the first transistor and the second transistor includes an NPN type bipolar transistor.
